(19) United States
(12) Patent Application Publication
(10) Pub. No.: US 2016/0004774 A1
(43) Pub. Date: Jan. 7, 2016

(54) INFORMATION RECOMMENDATION METHOD AND APPARATUS AND INFORMATION RECOMMENDATION SYSTEM

(71) Applicant: Tencent Technology (Shenzhen) Company Limited, Shenzhen (CN)

(72) Inventor: Xiaokang SU, Shenzhen (CN)

(21) Appl. No.: 14/852,176

(22) Filed: Sep. 11, 2015

Related U.S. Application Data
(63) Continuation of application No. PCT/CN2014/073545, filed on Mar. 17, 2014.

(30) Foreign Application Priority Data
Mar. 27, 2013 (CN) 201310102583.4

(51) Int. Cl. G06F 17/30; G06F 3/0484; G06F 3/0482; H04L 29/08

(52) U.S. Cl. CPC G06F 17/30864; H04L 67/2895; G06F 17/30477; G06F 17/30554; G06F 3/0484; G06F 3/0482; G06F 17/30542

(57) ABSTRACT

The present technology provides an information recommendation method and apparatus, and an information recommendation system. The method performed by a client includes: acquiring a search keyword entered by a user; sending a search request containing the search keyword to a proxy server. The proxy server acquires multiple suggested keywords according to the search keyword, sends the suggested keywords to a resource server, and receives multiple information resources, each according to a corresponding one of the suggested keywords; receiving the suggested keywords and an information resource associated with at least one of the suggested keywords; displaying the suggested keywords on a screen of the client; and in response to a user selection of the at least one of the suggested keywords on the screen, replacing the display of the suggested keywords with a display of the information resource associated with the user-selected suggested keyword.

### RELATED APPLICATIONS

The application is a continuation application of PCT Patent Application No. PCT/CN2014/073545, entitled “INFORMATION RECOMMENDATION METHOD AND APPARATUS AND INFORMATION RECOMMENDATION SYSTEM” filed on Mar. 17, 2014, which claims priority to Chinese Patent Application No. 201310102583.4, entitled “INFORMATION RECOMMENDATION METHOD AND APPARATUS AND INFORMATION RECOMMENDATION SYSTEM” and filed on Mar. 27, 2013, both of which are incorporated by reference in their entirety.

### FIELD OF THE TECHNOLOGY

The present application relates to the field of computer technologies, and in particular, to an information recommendation method and apparatus, and an information recommendation system.

### BACKGROUND OF THE DISCLOSURE

With the continuous development of mobile terminal (for example, a computer and a cellular phone) technologies and communications technologies, a mobile terminal plays an increasingly important role in daily life of people, and affects the way people live and work. Moreover, acquiring various information by search is an important function of the mobile terminal.

Currently, a process of searching for and acquiring information by the mobile terminal is as follows: A user enters a search keyword in a search box of a browser of the mobile terminal; and a search engine server infers a search intention of the current user according to the search keyword entered by the user and search cases of most users, so as to provide a search suggestion to the user, and presents, by using a drop-down list of the browser, a search keyword completed according to the search suggestion. In the foregoing search process, only a text drop-down selection area in which the search keyword can be completed is provided to the user. After the user selects a search keyword through clicking, the search keyword is transferred to a search engine for search, and the user needs to search repeatedly in a result page returned by the search engine to locate content and a target address that are finally required.

In summary, recommendation information provided by existing terminal device is limited. Moreover, the terminal device information recommendation cannot accurately and directly help a user to locate required target content, having low search efficiency.

### SUMMARY

In consideration of the foregoing problems, the present application provides the following technical solutions:

According to an aspect of the present technology, an information recommendation method is performed by a client having one or more processors, memory and a plurality of program units stored in the memory and to be executed by the one or more processors, the method comprising:

acquiring a search keyword entered by a user;

sending a search request containing the search keyword to a proxy server, wherein the proxy server acquires multiple suggested keywords according to the search keyword contained in the search request, sends the suggested keywords to a resource server, and receives multiple information resources, wherein each information resource is acquired by the resource server by performing a search according to a corresponding one of the suggested keywords;

receiving the suggested keywords and an information resource associated with at least one of the suggested keywords returned by the proxy server;

displaying the suggested keywords on a screen of the client; and

in response to a user selection of the at least one of the suggested keywords on the screen, replacing the display of the suggested keywords with a display of the information resource associated with the user-selected suggested keyword.

According to another aspect of the present technology, an information recommendation method is performed by a proxy server having one or more processors, memory and a plurality of program units stored in the memory and to be executed by the one or more processors, the method comprising:

receiving a search request sent by a client, the search request containing a search keyword;

acquiring multiple suggested keywords according to the search keyword contained in the search request;

sending the suggested keywords to a resource server, so that the resource server performs a search according to each suggested keyword to acquire at least one information resource;

receiving the information resources returned by the information resource server; and

sending the suggested keywords and an information resource associated with at least one of the suggested keywords to the client, wherein the client displays the suggested keywords and then the information resource in response to a user selection of the at least one of the suggested keywords.

According to another aspect of the present technology, a proxy server includes one or more processors; memory; and a plurality of program units stored in the memory and to be executed by the one or more processors, the plurality of program units further including:

a search request receiving unit, configured to receive a search request sent by a client, the search request containing a search keyword entered by a user;

a suggested keyword acquiring unit, configured to acquire multiple suggested keywords according to the search keyword contained in the search request;

a suggested keyword sending unit, configured to send the suggested keywords to a resource server, so that the resource server performs a search according to each suggested keyword to acquire at least one information resource;

an information resource receiving unit, configured to receive the information resources returned by the information resource server; and

an information resource sending unit, configured to send the suggested keywords and an information resource associated with at least one of the suggested keywords to the client, wherein the client displays the suggested keywords and then the information resource in response to a user selection of the at least one of the suggested keywords.

According to the present technology, a client acquires a search keyword entered by a user, and sends a search request containing the search keyword to a proxy server, wherein the proxy server acquires multiple suggested keywords according to the search keyword contained in the search request, sends the suggested keywords to a resource server, and receives an information resource that is acquired by the resource server by performing a search according to each corresponding suggested keyword; and the client receives the information resource returned by the proxy server, resolves the information resource, and further displays the resolved information resource on a screen of the client. Therefore, the user can directly select and locate a required information resource from displayed information resources without searching for a link wanted by the user in a search result page acquired according to a search suggestion, which greatly improves search efficiency.

### BRIEF DESCRIPTION OF THE DRAWINGS

To describe the technical solutions of the embodiments of the present application more clearly, the following briefly introduces the accompanying drawings required for describing the embodiments. Apparently, the accompanying drawings in the following description show only some embodiments of the present application, and a person of ordinary skill in the art may still derive other drawings from these accompanying drawings without creative efforts.

FIG. 1 is a schematic structural diagram of an information recommendation system according to Embodiment 1 of the present technology;

FIG. 2 is a flowchart of an information recommendation method according to Embodiment 1 of the present technology;

FIG. 3A and FIG. 3B are schematic diagrams of displaying an information resource by a client according to Embodiment 1 of the present technology;

FIG. 4 is a flowchart of an information recommendation method according to Embodiment 2 of the present technology;

FIG. 5 is a flowchart of an information recommendation method according to Embodiment 3 of the present technology;

FIG. 6 is a schematic structural diagram of a resource server according to Embodiment 3 of the present technology;

FIG. 7 is a schematic structural diagram of an information recommendation apparatus according to Embodiment 4 of the present technology;

FIG. 8 is a schematic structural diagram of an information recommendation apparatus according to Embodiment 5 of the present technology;

FIG. 9 is a schematic structural diagram of an information recommendation apparatus according to Embodiment 6 of the present technology;

FIG. 10 is a schematic structural diagram of an information recommendation system according to Embodiment 7 of the present technology;

FIG. 11 is a flowchart of an information recommendation method of the information recommendation system according to Embodiment 7 of the present technology;

FIG. 12 is a schematic structural diagram of an information recommendation system according to Embodiment 8 of the present technology; and

FIG. 13 is a schematic structural diagram of an information recommendation apparatus according to Embodiment 9 of the present technology.

### DESCRIPTION OF EMBODIMENTS

To make the objectives, technical solutions, and advantages of the present technology clearer, the following further describes the present technology in detail with reference to the accompanying drawings and the embodiments. It should be understood that the specific embodiments described herein are only used to explain the present technology, rather than to limit the present technology.

In the present technology, a mobile terminal acquires a search keyword entered by a user, acquires, according to the search keyword, a search suggestion provided by a search engine, performs a match with a background resource server according to the search suggestion, directly presents a matching resource in a search drop-down box of the user, and displays the matching resource on a display screen of the mobile terminal.

The following describes implementation of the present technology in detail by using specific embodiments.

### Embodiment 1

An application scenario of this embodiment is as follows: Referring to FIG. 1, an information recommendation system, includes: a client 11, where the client may be a terminal device such as a tablet computer, a PC, a notebook computer, a PAD; a proxy server 12; and a resource server 13. The client 11 is configured to initiate a search request to the proxy server 12 and display an acquired information resource; the proxy server 12 is configured to communicate with the client 11 and the resource server 13, for example, forwarding data and an instruction in a process of interaction between devices such as the client 11 and the resource server 13; and the resource server 13 is configured to provide the information resource to the client 11, which are described below in detail by using an embodiment.

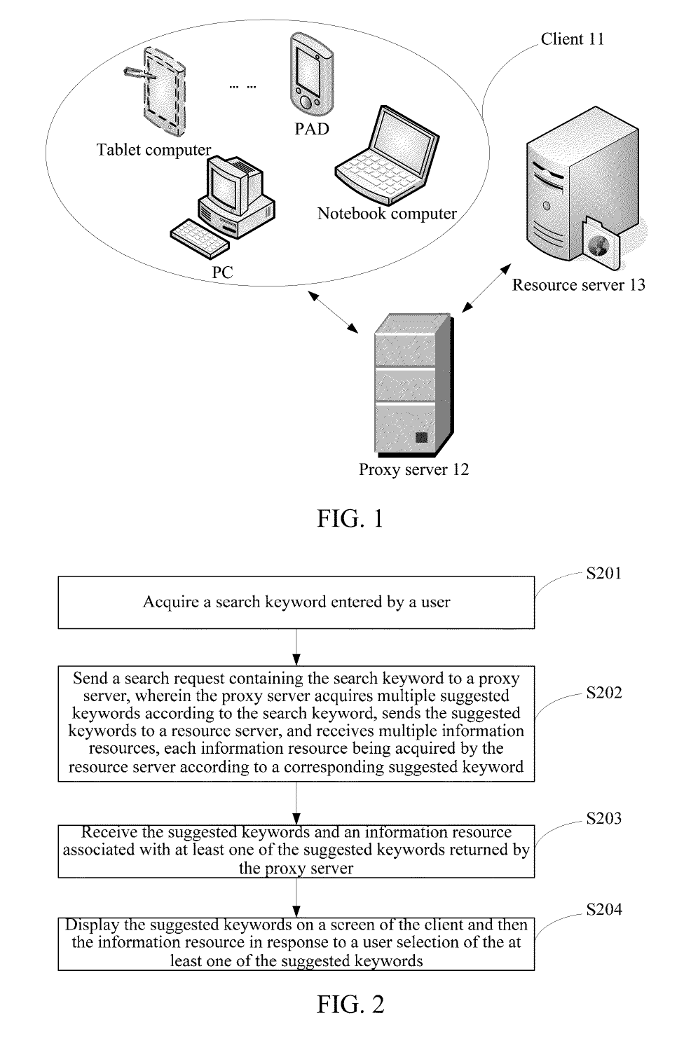

FIG. 2 shows a flowchart of an information recommendation method according to Embodiment 1 of the present technology. For example, the method may be used on a client side of the information recommendation system, and the method may include the following steps:

S201: Acquire a search keyword entered by a user.

S202: Send a search request containing the search keyword to a proxy server, wherein the proxy server acquires multiple suggested keywords according to the search keyword contained in the search request, sends the suggested keywords to a resource server, and receives an information resource that is acquired by the resource server by performing a search according to each corresponding suggested keyword.

Therefore, the found information resource is an information resource related to the search keyword and may be a multimedia resource. In this embodiment, the information resource may be an information resource such as a video, audio, a text, or a web page.

S203: Receive the suggested keywords and an information resource associated with at least one of the suggested keywords returned by the proxy server.

S204: Display the suggested keywords on a screen of the client and then the information resource in response to a user selection of the at least one of the suggested keywords.

In this embodiment, the client resolves the information resource in a data packet returned by the proxy server, identifies a type of the returned resource (for example, news, novel, software, or video), and displays the identified information resource on the screen of the client.

In this embodiment, the step of displaying the information resource in S204 may include: displaying the resolved information resource in a drop-down list of a search keyword on the screen of the client, and displaying the user-selected suggested keyword in a manner visually different from the other suggested keywords.

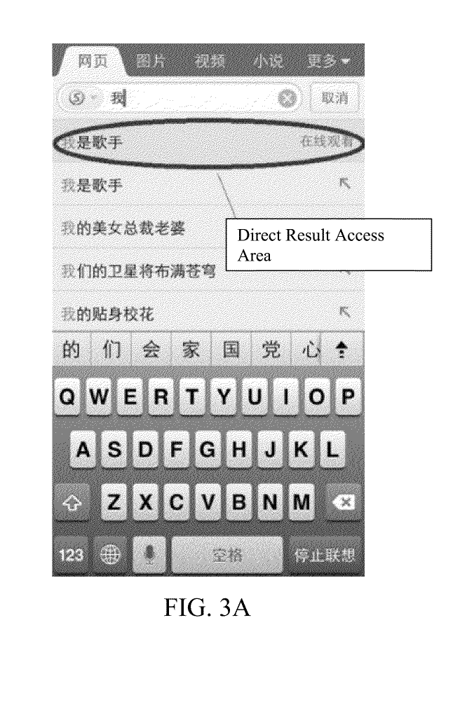

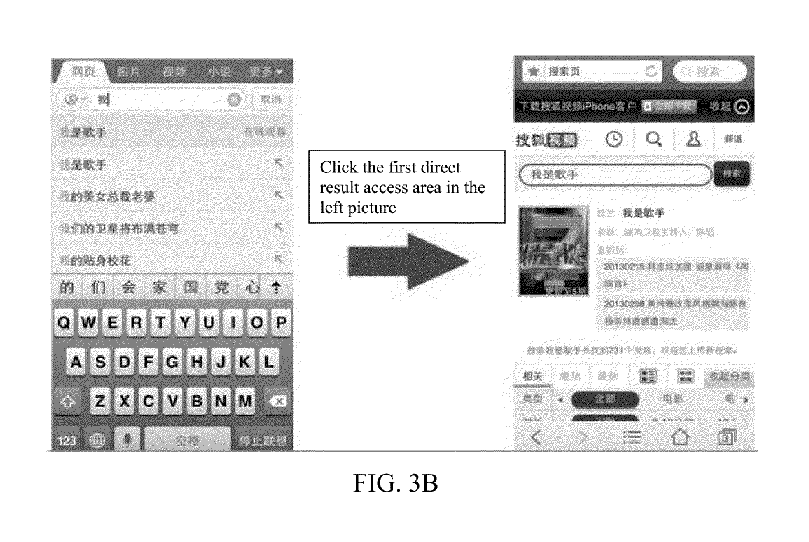

For ease of understanding, a method for displaying the information resource in this embodiment is described by using a specific implementation example, but is not limited to a case of this implementation example. For example, when a user enters a search keyword “ [symbol] ” (Chinese equivalent of “I”) in an input box of the client, the client sends a search request to the proxy server, where the search request contains the search keyword “I”; the proxy server acquires a suggested keyword related to “I” according to the search keyword, for example, “I am a singer”, and provides the multiple suggested keywords to the resource server; the resource server acquires a corresponding information resource according to each suggested keywords, for example, video content of “I am a singer”, and sends the information resource to the client; and the client displays the acquired information resource. As shown in FIG. 3A, the user can directly click and directly watch an “I am a singer” video without performing a search, as shown in FIG. 3B. Note that some of the suggested keywords include the user-entered search keyword and others of the suggested keywords do not include the user-entered search keyword. As shown in FIG. 3A, the first suggested keyword “I am a singer” is displayed in a manner visually different from the other suggested keywords. For example, there is text prompting the user that the information source associated with the first suggested keyword “I am a singer” is readily available and a user can view the information source by tapping the prompt information next to the first suggested keyword “I am a singer”. On the other hand, a user selection of the other suggested keywords triggers a new search request to the proxy server and does not have the readily available information source.

In this embodiment, a client acquires a search keyword entered by a user, and sends a search request to a proxy server, wherein the proxy server acquires multiple suggested keywords according to the search keyword contained in the search request, sends the suggested keywords to a resource server, receives an information resource that is acquired by the resource server by performing a search according to each corresponding suggested keyword, and sends the received information resource to the client; and the client receives the information resource returned by the proxy server, resolves the information resource, and further displays the information resource on a screen of the client. Therefore, the user can directly select and locate a required information resource from displayed information resources without searching for a link wanted by the user in a search result page acquired according to a search suggestion, which greatly improves search efficiency.

### Embodiment 2

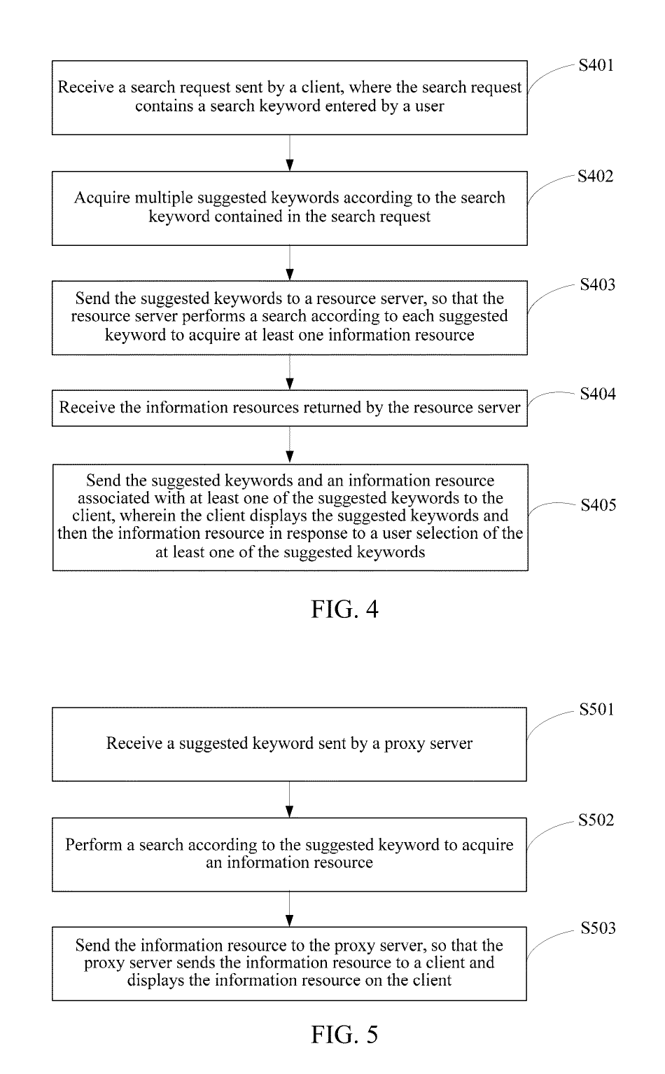

Referring to FIG. 4, FIG. 4 shows a flowchart of an information recommendation method according to Embodiment 2 of the present technology. For example, the method may be used on a proxy server side of the information recommendation system, and the method may include the following steps:

S401: Receive a search request sent by a client, where the search request contains a search keyword entered by a user.

S402: Acquire multiple suggested keywords according to the search keyword contained in the search request.

In this embodiment, for example, the suggested keywords are a set of keywords that are acquired by the proxy server by performing a fuzzy search according to the search keyword and a predetermined search algorithm, are related to the search keyword, and may be used by the user; there may be one or more suggested keywords.

Optionally, the proxy server acquires the multiple suggested keywords according to the search keyword carried in the search request by: sending, by the proxy server, the search keyword to a search engine, and receiving the suggested keywords acquired by the search engine by performing a search according to the search keyword. For example, the search engine may be a Baidu search engine, a Sogou search engine, or a Google search engine. Specifically, the proxy server requests the search engine to acquire the suggested keyword, and a search engine server performs a search according to the search keyword and search behaviors of most users to acquire the suggested keyword.

S403: Send the suggested keywords to a resource server, so that the resource server performs a search according to each suggested keyword to acquire at least one information resource.

In this embodiment, the suggested keyword may include one or more keywords. The proxy server may package the search request containing the suggested search keyword as a one-time search behavior, and send the suggested search keyword to the resource server.

S404: Receive the information resources returned by the information resource server and rank the information resources by their associated suggested keywords.

S405: Send the suggested keywords and an information resource associated with at least one of the suggested keywords to the client, wherein the client displays the suggested keywords and then the information resource in response to a user selection of the at least one of the suggested keywords. In this embodiments, the suggested keywords and the information resource sent by the proxy server are based on their ranks.

In this embodiment, a proxy server receives a search request sent by a client; acquires a suggested keyword according to a search keyword contained in the search request; sends the suggested keywords to a resource server, so that the resource server performs a search according to each suggested keyword to acquire at least one information resource; receives the information resources returned by the information resource server; and sends the suggested keywords and an information resource associated with at least one of the suggested keywords to the client, wherein the client resolves the information resource and displays the information resource on a screen of the client. Therefore, a user can directly select and locate a required information resource from displayed information resources without searching for a link wanted by the user in a search result page acquired according to a search suggestion, which greatly improves search efficiency.

### Embodiment 3

FIG. 5 shows a flowchart of an information recommendation method according to Embodiment 3 of the present technology. For example, the method may be used on a resource server side of the information recommendation system, and the method may include the following steps:

S501: Receive a suggested keyword sent by a proxy server.

As described above, the suggested keyword is acquired by the proxy server according to a search keyword entered by a user.

S502: Perform a search according to the suggested keyword to acquire an information resource.

In this embodiment, for example, S502 may include: performing the search in a preset resource database according to the suggested keyword to acquire the information resource, where the resource database pulls the information resource from a specified resource server, and classifies and stores the information resource according to a preset rule.

After pulling the information resource from the specified resource server, the resource server performs page extraction on resource data in the preset resource database according to a data extraction template to extract useful information in the information resource, so that an information resource provided to the user is more effective and more accurate. Further, typesetting optimization may be further performed on the resource data in the preset resource database according to a display feature of a terminal device, so that the information resource matches a screen of the terminal device.

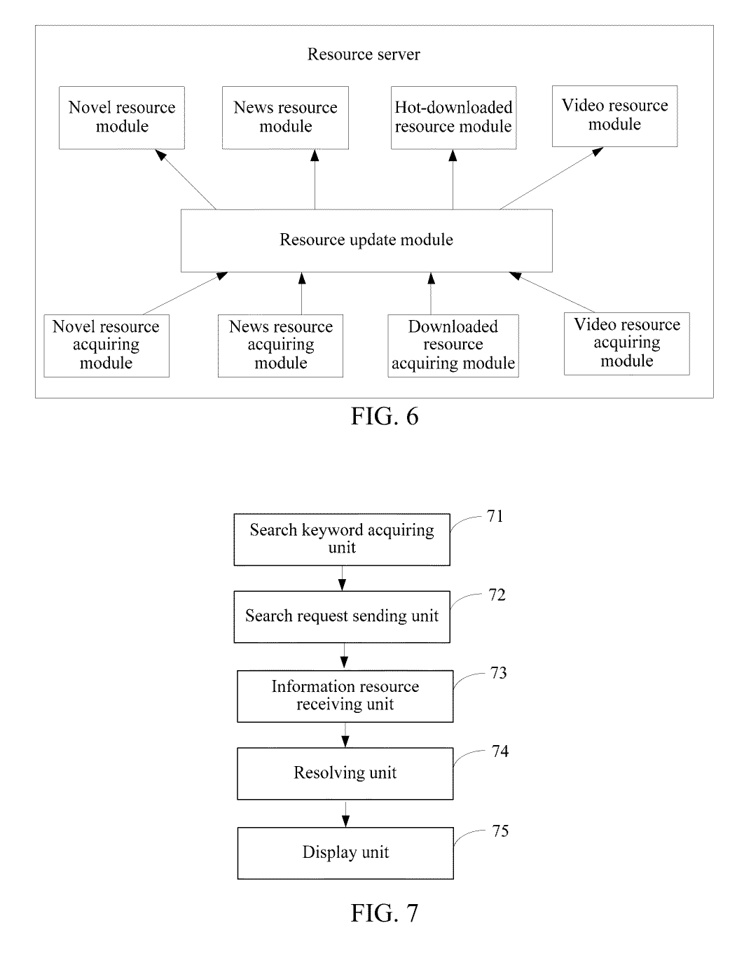

FIG. 6 is a schematic structural diagram of a resource server according to Embodiment 3 of the present technology. The resource server may provide vertical resources such as a news resource, a novel resource, and a software (game) resource for downloading, and video resource for online watching. The vertical resources are stored in the resource server after processing, for example, resource selection, automatic content extraction, and typesetting optimization presentation. Specifically, the resource server may include: a novel resource module storing a novel resource; a news resource module storing a news resource; a hot-downloaded resource module storing a hot-downloaded resource; a video resource module storing a video resource; a resource update module, configured to update the resources of the modules at regular time; a novel resource acquiring module, configured to acquire the novel resource, perform web page extraction on the acquired novel resource to remove information such as an advertisement and a picture therein, and perform processing such as typesetting optimization on the processed novel resource; a news resource acquiring module, configured to acquire the news resource, perform web page extraction on the acquired news resource to remove information such as an advertisement and a picture therein, and perform processing such as typesetting optimization on the processed news resource; a downloaded resource acquiring module, configured to acquire the hot-downloaded resource, perform web page extraction on the acquired hot-downloaded resource to remove information such as an advertisement and a picture therein, and perform processing such as typesetting optimization on the processed hot-downloaded resource; and a video resource acquiring module, configured to acquire the video resource, perform web page extraction on the acquired video resource to remove information such as an advertisement and a picture therein, and perform processing such as typesetting optimization on the processed video resource. Certainly, a person skilled in the art will learn that what is shown in FIG. 6 is merely one exemplary structure of the resource server, and a resource server that can be used is not limited thereto.

S503: Send the information resource to the proxy server, so that the proxy server sends the information resource to a client and displays the information resource on the client.

In this embodiment, a resource server receives a suggested keyword that is acquired according to a search keyword entered by a user and is sent by a proxy server, performs a search according to the suggested keyword to acquire an information resource, and sends the information resource to the proxy server, so that the proxy server sends the information resource to a client and displays the information resource on the client. Therefore, the user can directly select and locate a required information resource from displayed information resources, which improves search efficiency. Moreover, information recommendation directing search content can be pushed to the user in time by means of a vertical information resource of the resource server without a problem that the user manually finds a high-quality resource from massive network information resources.

### Embodiment 4

FIG. 7 shows a schematic structural diagram of an information recommendation apparatus according to Embodiment 4 of the present technology. For ease of description, only the part related to this embodiment of the present application is shown. The apparatus may be a software unit, a hardware unit, or a combination unit of software and hardware built into a mobile terminal.

The apparatus may include: a search keyword acquiring unit 71, a search request sending unit 72, an information resource receiving unit 73, a resolving unit 74, and a display unit 75.

The search keyword acquiring unit 71 is configured to acquire a search keyword entered by a user; the search request sending unit 72 is configured to send a search request containing the search keyword to a proxy server, wherein the proxy server acquires multiple suggested keywords according to the search keyword contained in the search request, sends the suggested keywords to a resource server, and receives an information resource that is acquired by the resource server by performing a search according to each corresponding suggested keyword; the information resource receiving unit 73 is configured to receive the information resource returned by the proxy server and provide the information resource to the resolving unit 74; the resolving unit 74 is configured to resolve the received information resource and provide the resolved information resource to the display unit 75; and the display unit 75 is configured to display the information resource on a screen of a client.

Optionally, the display unit 75 may display the information resource in a drop-down list of the search keyword on the screen of the client, and display information prompting that the information resource can be directly acquired.

The information recommendation apparatus provided in this embodiment of the present technology can be used in the corresponding method Embodiment 1 described above, and for details, reference is made to the description in the foregoing Embodiment 1, which are not described herein again.

### Embodiment 5

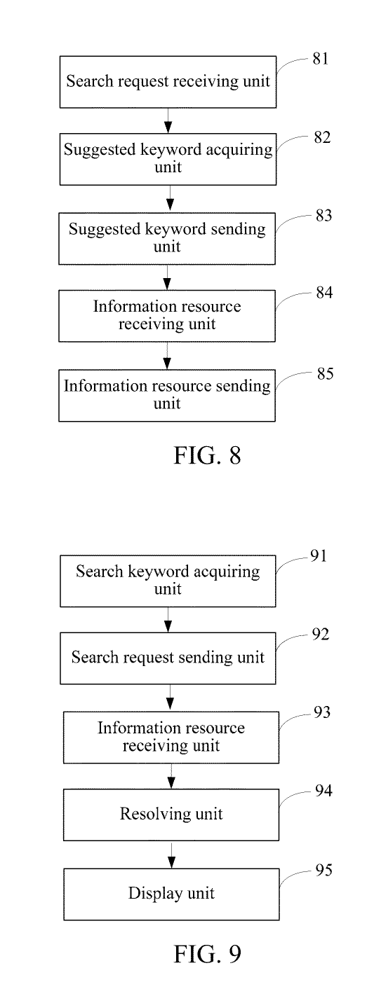

FIG. 8 shows a schematic structural diagram of an information recommendation apparatus according to Embodiment 5 of the present technology. For ease of description, only the part related to this embodiment of the present application is shown. The apparatus may be a software unit, a hardware unit, or a combination unit of software and hardware built into a mobile terminal.

The apparatus may include: a search request receiving unit 81, a suggested keyword acquiring unit 82, a suggested keyword sending unit 83, an information resource receiving unit 84, an information resource sending unit 85.

The search request receiving unit 81 is configured to receive a search request sent by a client, where the search request contains a search keyword entered by a user; the suggested keyword acquiring unit 82 is configured to acquire multiple suggested keywords according to the search keyword contained in the search request; the suggested keyword sending unit 83 is configured to send the suggested keywords to a resource server, so that the resource server performs a search according to each suggested keyword to acquire at least one information resource; the information resource receiving unit 84 is configured to receive the information resources returned by the information resource server; and the information resource sending unit 85 is configured to send the suggested keywords and an information resource associated with at least one of the suggested keywords to the client, wherein the client displays the suggested keywords and then the information resource in response to a user selection of the at least one of the suggested keywords.

Optionally, the suggested keyword acquiring unit 82 may be configured to send the search keyword to a search engine that communicates with the information recommendation apparatus, and receive the suggested keyword that is acquired by the search engine by performing a search according to the suggested keyword.

The information recommendation apparatus provided in this embodiment of the present technology can be used in the corresponding method Embodiment 2 described above, and for details, reference is made to the description in the foregoing Embodiment 2, which are not described herein again.

### Embodiment 6

FIG. 9 shows a schematic structural diagram of an information recommendation apparatus according to Embodiment 6 of the present technology. For ease of description, only the part related to this embodiment of the present application is shown. The apparatus may be a software unit, a hardware unit, or a combination unit of software and hardware built into a mobile terminal.

The apparatus may include: a suggested keyword receiving unit 91, an information resource search unit 92, and an information resource sending unit 93.

The suggested keyword receiving unit 91 is configured to receive a suggested keyword sent by a proxy server; the information resource search unit 92 is configured to perform a search according to the suggested keyword to acquire an information resource; and the information resource sending unit 93 is configured to send the information resource to the proxy server, so that the proxy server sends the information resource to a client and displays the information resource on the client.

As described above, the suggested keyword is acquired by the proxy server according to a search keyword entered by a user.

Optionally, the information resource search unit 92 may perform the search in a preset resource database according to the suggested keyword to acquire the information resource, where the resource database pulls the information resource from a specified resource server, and classifies and stores the information resource according to a preset rule.

Optionally, the apparatus may further include: a page extraction unit, configured to perform page extraction on resource data in the preset resource database according to a data extraction template, so that the information resource search unit 92 searches for the information resource in the resource data extracted by the page extraction unit.

Optionally, the apparatus may further include: a typesetting optimization unit, configured to perform typesetting optimization on resource data in the preset resource database according to a display feature of a terminal device.

The information recommendation apparatus provided in this embodiment of the present technology can be used in the corresponding method Embodiment 3 described above, and for details, reference is made to the description in the foregoing Embodiment 3, which are not described herein again.

### Embodiment 7

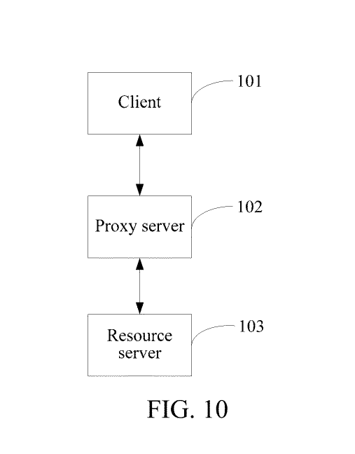

FIG. 10 shows a schematic structural diagram of an information recommendation system according to Embodiment 7 of the present technology. For ease of description, only the part related to this embodiment of the present application is shown.

The system may include: a client 101, a proxy server 102, and a resource server 103.

The client 101 acquires a search keyword entered by a user, sends a search request containing the search keyword to the proxy server 102, receives an information resource returned by the proxy server 102, resolves the information resource, and displays the information resource on a screen of the client.

The proxy server 102 receives the search request sent by the client 101, acquires multiple suggested keywords according to the search keyword contained in the search request, sends the suggested keyword to the resource server 103, receives the information resource returned by the resource server 103, and sends the information resource to the client 101.

The resource server 103 receives the suggested keyword sent by the proxy server 102, performs a search according to the suggested keyword to acquire the information resource, and sends the information resource to the proxy server 102.

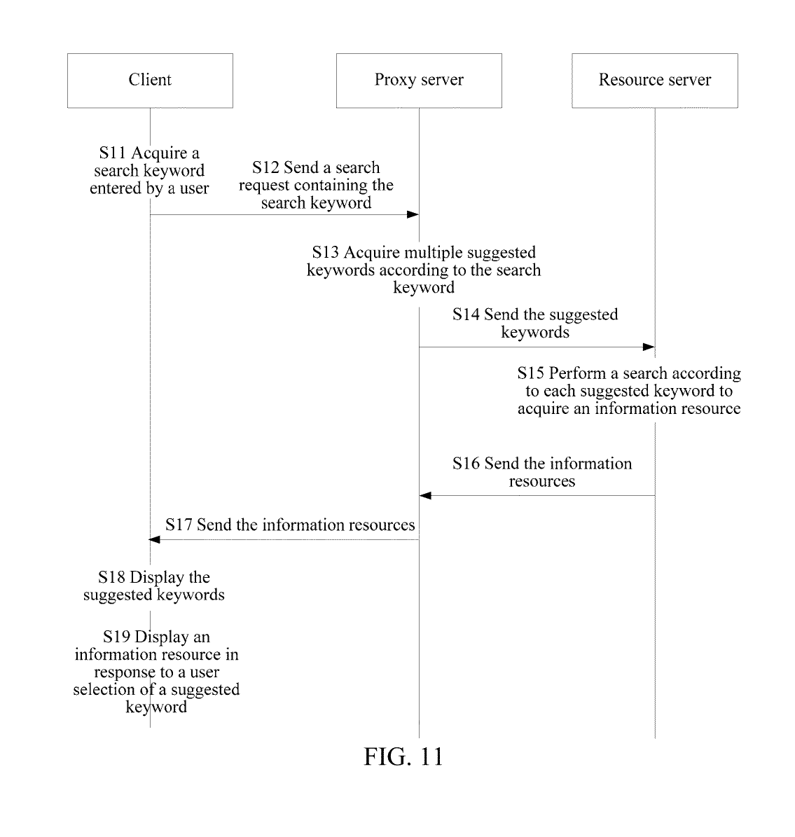

FIG. 11 shows a flowchart of an information recommendation method performed by the information recommendation system according to this embodiment of the present technology. The method may include the following steps:

S11: The client acquires a search keyword entered by a user.

S12: The client sends a search request to the proxy server, where the search request contains the search keyword.

In this embodiment, after pre-establishing a communication connection to the proxy server, the client initiates the search request to the proxy server according to the search keyword.

S13: The proxy server receives the search request sent by the client, and acquires multiple suggested keywords according to the search keyword contained in the search request.

S14: The proxy server sends the suggested keyword to the resource server.

S15: The resource server receives the suggested keyword sent by the proxy server, and performs a search according to the suggested keyword to acquire an information resource.

In this embodiment, the resource server performs the search according to the suggested keyword and a search history of the user to acquire a matching vertical information resource, and returns the acquired resource to the proxy server, that is, S16 is performed.

S16: The resource server sends the information resource to the proxy server.

S17: The proxy server receives the information resource returned by the resource server, and sends the information resource to the client.

In this embodiment, the proxy server returns the acquired information resource to the client by using the pre-established communication connection.

S18: The client receives the information resource returned by the proxy server, and resolves the information resource.

S19: The client displays the information resource on a screen of the client.

In this embodiment, a client of a mobile terminal acquires a search keyword entered by a user, and sends a search request containing the search keyword to a proxy server; the proxy server acquires multiple suggested keywords according to the search keyword contained in the search request, and sends the suggested keywords to a resource server; the resource server performs a search according to each suggested keyword to acquire at least one information resource, and sends the information resource to the proxy server; the proxy server sends the information resource to the client; and the client receives the information resource returned by the proxy server, resolves the information resource, and displays the information resource on a screen of the client. Therefore, the user can directly select and locate a required information resource from displayed information resources without searching for a link wanted by the user in a search result page acquired according to a search suggestion, which greatly improves search efficiency. In addition, information recommendation directing search content can be pushed to the user in time by means of a vertical information resource of the resource server without a problem that the user manually finds a high-quality resource from massive network information resources.

### Embodiment 8

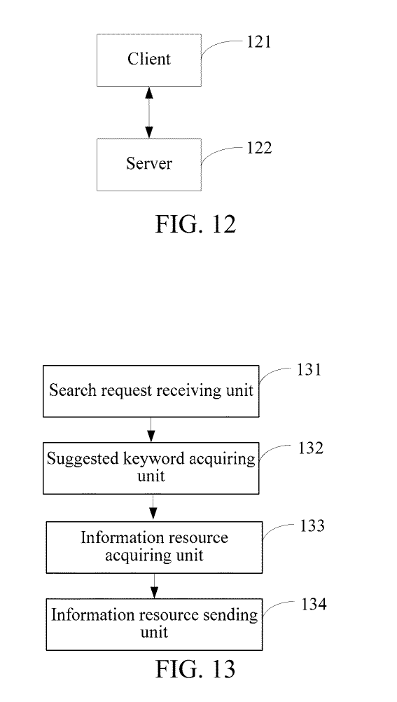

Although a proxy server and a resource server in the foregoing embodiments are described as two separate servers, a person skilled in the art may understand that functions of the two servers may be implemented by a single server. For example, FIG. 12 shows a structural diagram of an information recommendation system according to Embodiment 8 of the present technology. For ease of description, only the part related to this embodiment of the present application is shown.

The system includes: a client 121 and a server 122.

The client 121 acquires a search keyword, sends a search request containing the search keyword to the server 122, receives an information resource returned by the server 122, resolves the information resource, and displays the information resource on a screen of the client 121.

The server 122 acquires multiple suggested keywords according to the search keyword contained in the search request, performs a search according to the suggested keyword to acquire the information resource, and sends the information resource to the client 121.

### Embodiment 9

FIG. 13 shows a schematic structural diagram of an information recommendation apparatus according to Embodiment 9 of the present technology. For ease of description, only the part related to this embodiment of the present application is shown. The apparatus may be a software unit, a hardware unit, or a combination unit of software and hardware built into a mobile terminal.

The apparatus may include: a search request receiving unit 131, a suggested keyword acquiring unit 132, an information resource acquiring unit 133, and an information resource sending unit 134.

The search request receiving unit 131 is configured to receive a search request sent by a client, where the search request contains a search keyword entered by a user; the suggested keyword acquiring unit 132 is configured to acquire multiple suggested keywords according to the search keyword contained in the search request; the information resource acquiring unit 133 is configured to perform a search according to the suggested keyword to acquire an information resource; and the information resource sending unit 134 is configured to send the suggested keywords and an information resource associated with at least one of the suggested keywords to the client, wherein the client displays the suggested keywords and then the information resource in response to a user selection of the at least one of the suggested keywords.

Optionally, the suggested keyword acquiring unit 132 may send the search keyword to a search engine, and receive the suggested keyword that is acquired by the search engine by performing a search according to the suggested keyword.

It should be noted that the units included in the foregoing embodiments are merely divided according to logical functions, but the present application is not limited to the division, as long as corresponding functions can be implemented; and in addition, specific names of the units or modules are merely provided for the purpose of distinguishing the units or modules from one another, but not intended to limit the protection scope of the present application.

Moreover, a person of ordinary skill in the art may understand that all or some of the steps of the foregoing method embodiments may be implemented by a program instructing relevant hardware. The corresponding program may be stored in a non-transitory computer readable storage medium. The storage medium may be a ROM/RAM, a magnetic disk, an optical disc, or the like.

The foregoing descriptions are merely preferred embodiments of the present application, but are not intended to limit the present application. Any modification, equivalent replacement, or improvement made within the spirit and principle of the present application shall fall within the protection scope of the present application.

What is claimed is:

1. An information recommendation method performed by a client having one or more processors, memory and a plurality of program units stored in the memory and to be executed by the one or more processors, the method comprising:
acquiring a search keyword entered by a user;
sending a search request containing the search keyword to a proxy server, wherein the proxy server acquires multiple suggested keywords according to the search keyword contained in the search request, sends the suggested keywords to a resource server, and receives multiple information resources, wherein each information resource is acquired by the resource server by performing a search according to a corresponding one of the suggested keywords;
receiving the suggested keywords and an information resource associated with at least one of the suggested keywords returned by the proxy server;
displaying the suggested keywords on a screen of the client; and
in response to a user selection of the at least one of the suggested keywords on the screen, replacing the display of the suggested keywords with a display of the information resource associated with the user-selected suggested keyword.

2. The method according to claim 1, wherein each suggested keyword is one or more keywords related to the search keyword that are acquired by the proxy server by performing a fuzzy search according to the search keyword and a predetermined search algorithm.

3. The method according to claim 1, wherein at least one of the multiple suggested keywords includes the user-entered keyword.

4. The method according to claim 1, wherein at least one of the multiple suggested keywords does not include the user-entered keyword.

5. The method according to claim 1, wherein the step of displaying the suggested keywords on a screen of the client comprises:
displaying the suggested keywords in a drop-down list of a search keyword on the screen of the client; and
displaying the user-selected suggested keyword in a manner visually different from the other suggested keywords.

6. The method according to claim 5, wherein the step of displaying the user-selected suggested keyword in a manner visually different from the other suggested keywords comprises: displaying information next the user-selected suggested keyword prompting the user that the information resource is readily available.

7. An information recommendation method performed by a proxy server having one or more processors, memory and a plurality of program units stored in the memory and to be executed by the one or more processors, the method comprising:
receiving a search request sent by a client, the search request containing a search keyword entered by a user;
acquiring multiple suggested keywords according to the search keyword contained in the search request;
sending the suggested keywords to a resource server, so that the resource server performs a search according to each suggested keyword to acquire at least one information resource;
receiving the information resources returned by the resource server, further including ranking the information resources by their associated suggested keywords; and
sending the suggested keywords and an information resource associated with at least one of the suggested keywords to the client, wherein the client displays the suggested keywords and then the information resource in response to a user selection of the at least one of the suggested keywords.

8. The method according to claim 7, wherein the step of acquiring multiple suggested keywords according to the search keyword contained in the search request comprises:
sending the search keyword to a search engine, and receiving the suggested keywords acquired by the search engine by performing a search according to the search keyword.

9. The method according to claim 7, wherein each suggested keyword is one or more keywords related to the search keyword that are acquired by the proxy server by performing a fuzzy search according to the search keyword and a predetermined search algorithm.

10. The method according to claim 7, wherein at least one of the multiple suggested keywords includes the user-entered keyword.

11. The method according to claim 7, wherein at least one of the multiple suggested keywords does not include the user-entered keyword.

12. A proxy server, comprising:
one or more processors;
memory; and
a plurality of program units stored in the memory and to be executed by the one or more processors, the plurality of program units further including:
a search request receiving unit, configured to receive a search request sent by a client, the search request containing a search keyword entered by a user;
a suggested keyword acquiring unit, configured to acquire multiple suggested keywords according to the search keyword contained in the search request;
a suggested keyword sending unit, configured to send the suggested keywords to a resource server, so that the resource server performs a search according to each suggested keyword to acquire at least one information resource;
an information resource receiving unit, configured to receive the information resources returned by the information resource server; and
an information resource sending unit, configured to send the suggested keywords and an information resource associated with at least one of the suggested keywords to the client, wherein the client displays the suggested keywords and then the information resource in response to a user selection of the at least one of the suggested keywords.

13. The proxy server according to claim 12, wherein the suggested keyword acquiring unit is configured to send the search keyword to a search engine, and receiving the suggested keywords acquired by the search engine by performing a search according to the search keyword.

14. The proxy server according to claim 12, wherein each suggested keyword is one or more keywords related to the search keyword that are acquired by the proxy server by performing a fuzzy search according to the search keyword and a predetermined search algorithm.

15. The proxy server according to claim 12, wherein at least one of the multiple suggested keywords includes the user-entered keyword.

16. The proxy server according to claim 12, wherein at least one of the multiple suggested keywords does not include the user-entered keyword.
